(19) United States
(12) Patent Application Publication
(10) Pub. No.: US 2010/0065020 A1
(43) Pub. Date: Mar. 18, 2010

(54) FUEL INJECTOR

(76) Inventors: Kenichi Kubo, Saitama (JP); Takehiko Ishikawa, Saitama (JP); Kiyoshi Matsuzaki, Saitama (JP)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/595,073

(22) PCT Filed: Feb. 25, 2008
(86) PCT No.: PCT/JP2008/053169

§ 371 Date: Oct. 8, 2009

(30) Foreign Application Priority Data
Apr. 9, 2007 (JP) 2007-101364

(51) Int. Cl. F02M 63/00; F02M 69/46

(52) U.S. Cl. 123/447; 123/456

(57) ABSTRACT

To provide a fuel injector that has excellent durability with respect to pressure of high-pressure fuel and can accurately perform injection control even when injecting even higher pressure fuel.

A fuel injector has, on a proximal end portion side of a nozzle needle inside an injector housing, a valve body in which a discharge hole for discharging high-pressure fuel is formed and a valve that opens and closes the discharge hole as a result of being lifted and seated in an axial direction, and a space between the valve body and the injector housing is open in the direction of an end portion of the valve body on the nozzle needle side, with the high-pressure fuel being passable through the space.

### TECHNICAL FIELD

The present invention relates to a fuel injector that injects fuel into an internal combustion engine or the like. In particular, the present invention relates to a fuel injector that is capable of injecting higher pressure fuel than conventionally.

### BACKGROUND ART

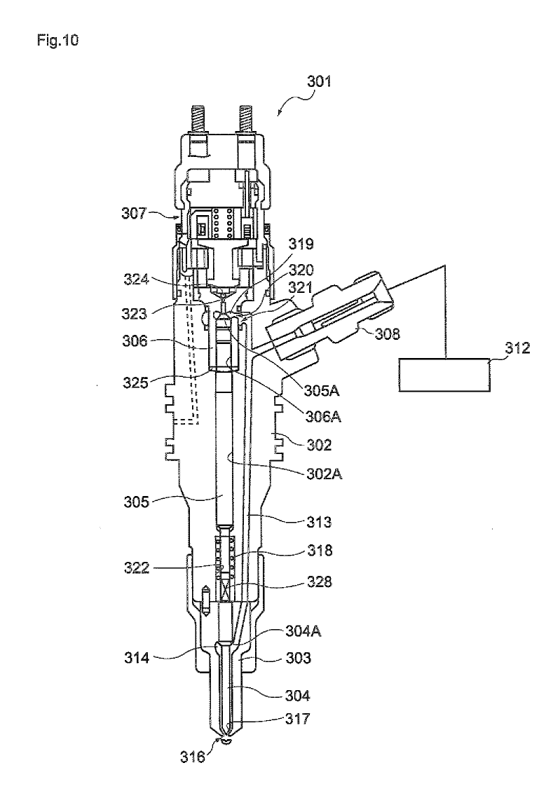

Conventionally, as a fuel injector that is used in order to inject high-pressure fuel supplied from a pressure accumulator (common rail) or the like into an internal combustion engine, for example, a fuel injector of the structure shown in FIG. 10 is known (patent document 1).

This fuel injector 301 is used in order to inject high-pressure fuel accumulated inside a common rail 312 into cylinders of a diesel internal combustion engine, and the fuel injector 301 has as its main components and is configured by an injector housing 302, a nozzle body 303, a nozzle needle 304, a valve piston 305, a valve body 306, a back pressure controller 307 and an inlet connector 308.

A fuel passage 313 is formed inside the fuel injector 301 from the inlet connector 308 to the injector housing 302 and the nozzle body 303. This fuel passage 313 is, en route to an injection hole 316 formed in the distal end portion of the nozzle body 303, communicated with a fuel reservoir chamber 314 formed in a site where a pressure-receiving portion 304A of the nozzle needle 304 is positioned.

The injection hole 316 formed in the distal end portion of the nozzle body 303 is formed in an arbitrary number, a seat portion 317 is formed in a site inside the nozzle body 303 that leads to the injection hole 316, and the nozzle needle 304 is seated and lifted with respect to the seat portion 317, whereby it becomes possible to open and close the injection hole 316.

A spring chamber 322 centered about the central axis of the injector housing 302 is formed in an appropriate position in the injector housing 302 above (in FIG. 10, on the upper side of) the nozzle needle 304. A nozzle spring 318 for energizing the nozzle needle 304 in the direction of the seat portion 317 is housed in this spring chamber 322, and a lift adjustment shim 328 is disposed between the valve piston 305 and the nozzle needle 304.

The valve piston 305 is a long rod-like member that extends from the spring chamber 322 portion to the upper portion of the injector housing 302 and is slidably inserted inside a sliding hole 302A formed in the injector housing 302 and a sliding hole 306A formed in the valve body 306. The uppermost portion of this valve piston 305 faces the back pressure controller 307 disposed in the upper portion of the valve body 306, and the lowermost portion of the valve piston 305 contacts the aforementioned lift adjustment shim 328.

As shown in FIG. 10, a back pressure control chamber 319 is formed in the valve body 306 where the uppermost portion of the valve piston 305 is positioned. The high-pressure fuel from the common rail 312 is introduced to this back pressure control chamber 319 via the fuel passage 313, a pressure introduction chamber 321 and an introduction orifice 320. Further, a seal member 325 resulting from a resin material, a rubber material, steel or another soft material is disposed in the lower end portion of the pressure introduction chamber 321, and the seal member 325 blocks off a high pressure side in the pressure introduction chamber 321 from a low pressure side inside the injector housing 302 where the valve piston 305 is housed.

The back pressure control chamber 319 is also communicated with an open/close orifice 323, and this open/close orifice 323 is opened and closed by control of the lifting of a valve ball 324 by the back pressure controller 307. When the valve ball 324 is lifted by the control of the back pressure controller 307 such that the open/close orifice 323 is opened, the high-pressure fuel in the back pressure control chamber 319 travels through an unillustrated circulation passage via the open/close orifice 323 and is returned to the low pressure side.

In the fuel injector 301 of this configuration, the valve piston 305, the lift adjustment shim 328 and the nozzle needle 304 are separate bodies, the lower end portion of the valve piston 305 contacts one surface of the lift adjustment shim 328, and the other surface of this lift adjustment shim 328 contacts the uppermost portion of the nozzle needle 304. The back pressure of the back pressure control chamber 319 acts on the nozzle needle 304 via these contact surfaces.

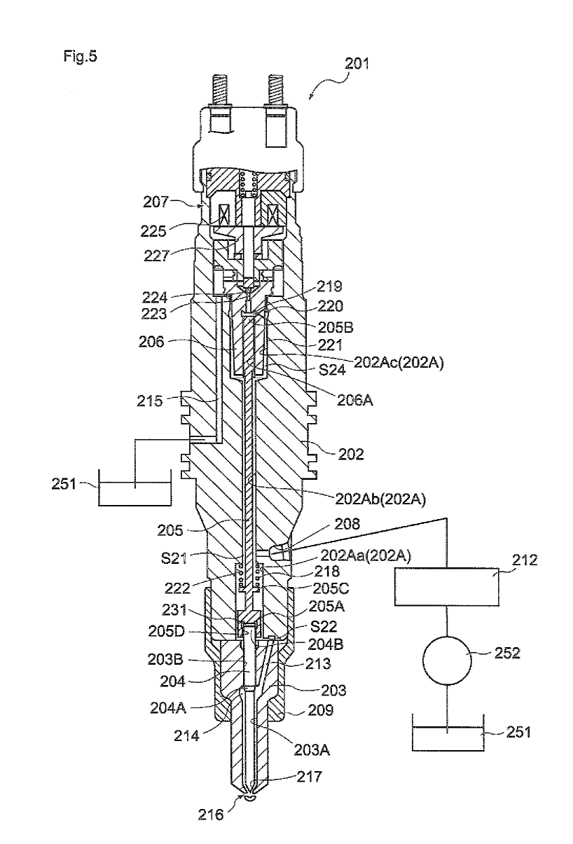

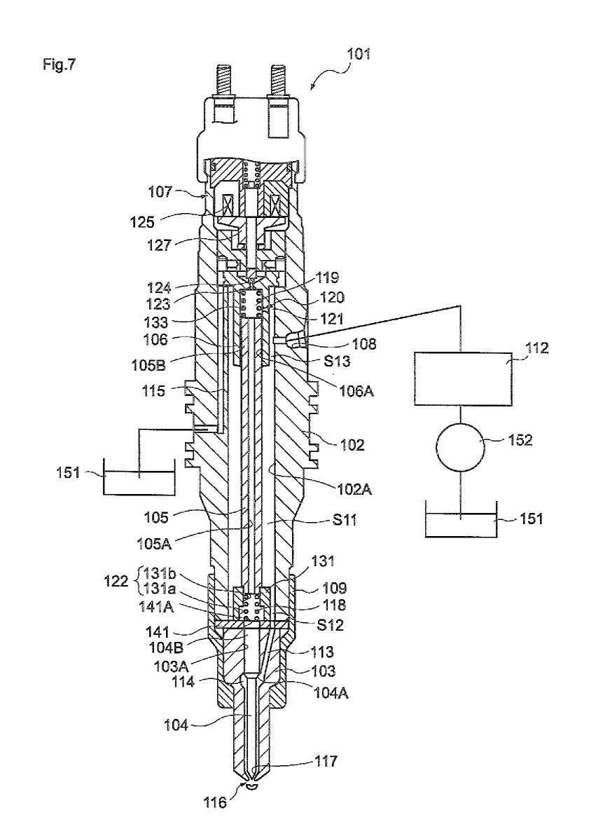

Consequently, when the high-pressure fuel is introduced to the back pressure control chamber 319 in a state where the open/close orifice 323 has been closed by the control of the back pressure controller 307, the pressure resulting from the high-pressure fuel acts near a proximal end portion 305A of the valve piston 305 and on the pressure-receiving portion 304A of the nozzle needle 304, the nozzle needle 304 becomes seated on the seat portion 317 by the back pressure of the back pressure control chamber 319 received via the lift adjustment shim 328 and the valve piston 305 and by the energizing force of the nozzle spring 318, and the injection hole 316 becomes closed. On the other hand, when the open/close orifice 323 has been opened by the control of the back pressure controller 307, the high-pressure fuel in the back pressure control chamber 319 is circulated to the fuel low pressure side via the open/close orifice 323, and the high pressure that had acted on the proximal end portion 305A of the valve piston 305 is released, so the nozzle needle 304 becomes lifted from the seat portion 317 counter to the energizing force of the nozzle spring 318 by the high pressure still acting on the pressure-receiving portion 304A of the nozzle needle 304, the injection hole 316 becomes opened, and fuel injection is performed.

[Patent Document 1] JP-A-2006-274942 (FIG. 5 and FIG. 7)

### DISCLOSURE OF THE INVENTION

### Problem that the Invention is to Solve

Incidentally, in recent years, even high-pressurization of the high-pressure fuel injected into the cylinders of internal combustion engines is advancing in accompaniment with emission cleaning standards becoming higher. However, in the fuel injector 301 of the conventional configuration shown in FIG. 10, the shim 328 is intervened between the valve piston 305 and the nozzle needle 304, and stress occurs in the places of contact between the shim 328 and the valve piston 305 and between the shim 328 and the nozzle needle 304 because of the pressure that the pressure-receiving portion 304A of the nozzle needle 304 receives and the back pressure that the proximal end portion 305A of the valve piston 305 receives. For that reason, there is the fear that, when the fuel supplied from the common rail 312 is pressurized to a high pressure, wear on the places of contact between the shim 328 and the valve piston 305 and between the shim 328 and the nozzle needle 304 will become intense and the injection characteristics will change.

Further, the common rail 312 and the fuel injector 301 are interconnected by a fuel pipe, the inside of the fuel injector 301 is also connected by an oil path, and the capacity in which the high-pressure fuel is held becomes relatively smaller. For that reason, there is the fear that, because of the opening and closing of the nozzle needle 304, large pressure waves resulting from the water hammer phenomenon will arise and the lifespan of each of the parts configuring the fuel injector 301 will drop.

Thus, the inventor of the present invention has made every effort to discover that this problem can be solved by omitting, of the components of the fuel injector, the valve piston, using only the nozzle needle to configure the member that is lifted and seated in order to open and close the injection hole, and opening a space between the valve body and the injector housing in a predetermined direction, and has thus completed the present invention.

That is, it is an object of the present invention to provide a fuel injector that has excellent durability with respect to pressure of high-pressure fuel and can accurately perform injection control even when injecting even higher pressure fuel.

### Means for Solving the Problem

According to the present invention, there is provided a fuel injector comprising a nozzle body in which an injection hole communicated with a high pressure fuel path is formed, a nozzle needle that is disposed so as to be movable in an axial direction inside the nozzle body and opens and closes the injection hole as a result of being lifted and seated, and an injector housing that is connected to the nozzle body and enables high-pressure fuel to be introduced to and discharged from a proximal end portion side of the nozzle needle in order to lift and seat the nozzle needle, wherein the fuel injector has, on the proximal end portion side of the nozzle needle inside the injector housing, a valve body in which a discharge hole for discharging the high-pressure fuel is formed and a valve that opens and closes the discharge hole as a result of being lifted and seated in the axial direction, and a space between the valve body and the injector housing is open in the direction of an end portion of the valve body on the nozzle needle side, with the high-pressure fuel being passable through the space; thus, the aforementioned problem can be solved.

Further, in configuring the fuel injector of the present invention, it is preferred that the nozzle needle is a long needle whose distal end portion is capable of being seated on a seat surface of the nozzle body and whose other end portion is slidably held in the valve body.

Further, in configuring the fuel injector of the present invention, it is preferred that a space between the long needle and the injector housing serves as a high pressure portion and is communicated with the space between the valve body and the injector housing.

Further, in configuring the fuel injector of the present invention, it is preferred that the proximal end portion of the nozzle needle is connected to a valve piston that is slidably held in the valve body, and the area around the valve piston serves as a high pressure portion.

Further, in configuring the fuel injector of the present invention, it is preferred that the fuel injector further comprises: an intermediate member that is disposed between the valve body and the nozzle needle and includes a high pressure fuel path, both of whose axial direction ends are open; and a nozzle spring that is disposed between the intermediate member and the nozzle needle and energizes the nozzle needle.

Further, in configuring the fuel injector of the present invention, it is preferred that the distal end portion of the nozzle needle is a pressure-receiving portion for lifting the nozzle needle.

### Effects of the Invention

In the fuel injector of the present invention, the fuel injector is configured such that the only member that is lifted and seated in order to open and close the injection hole is the nozzle needle, and by opening the space between the valve body and the injector housing downward (the injection hole side of the fuel injector), the number of places of contact between members when opening and closing the injection hole can be reduced and the capacity of the high-pressure fuel held inside the fuel injector can be increased. Consequently, wear and strain of members resulting from contact between members and pulsation of fuel pressure are reduced and the durability of the fuel injector can be improved. For that reason, the fuel injector can accurately perform injection control even when injecting higher pressure fuel than conventionally.

Further, in the fuel injector of the present invention, by employing the long needle, the number of parts is reduced, production costs can be lowered and the durability of the fuel injector can be improved.

Further, in the fuel injector of the present invention, by configuring the area around the long needle as a high pressure portion, the capacity of the high-pressure fuel held inside the fuel injector can be increased without having to greatly change a conventional configuration.

Further, in the fuel injector of the present invention, by connecting the nozzle needle to the valve piston and configuring the area around the valve piston as a high pressure portion, clearances of the sliding surface inside the nozzle body and the sliding surface inside the valve body can easily be placed in a suitable state in comparison to when the long needle is employed.

Further, in the fuel injector of the present invention, by disposing the predetermined intermediate member between the nozzle needle and the valve body, the nozzle needle can be made the only member that is lifted and seated, without having to make large changes to a conventional nozzle needle.

Further, in the fuel injector of the present invention, by configuring the distal end portion of the nozzle needle as a pressure-receiving portion, the fuel reservoir chamber is omitted, working of the nozzle body becomes easy and the capacity of the high-pressure fuel accumulated inside the fuel injector is large, so damage to members resulting from pulsation of fuel pressure can be reduced.

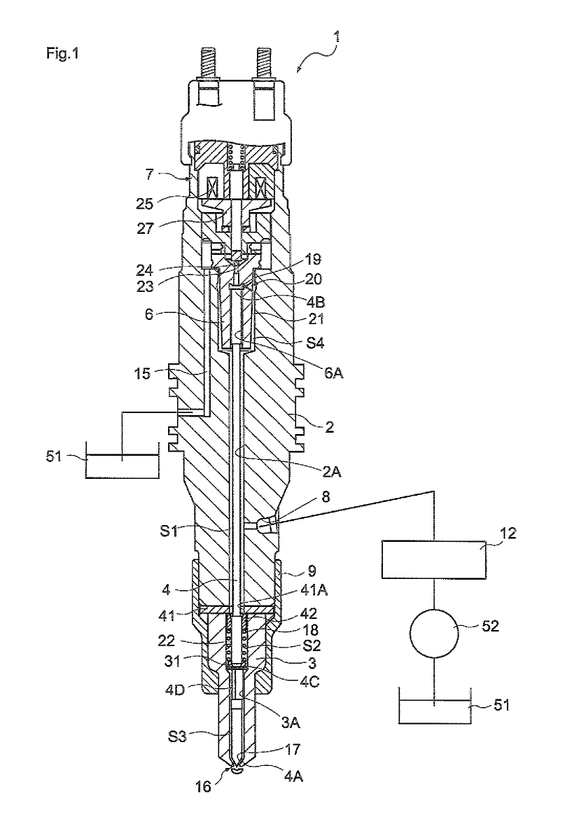

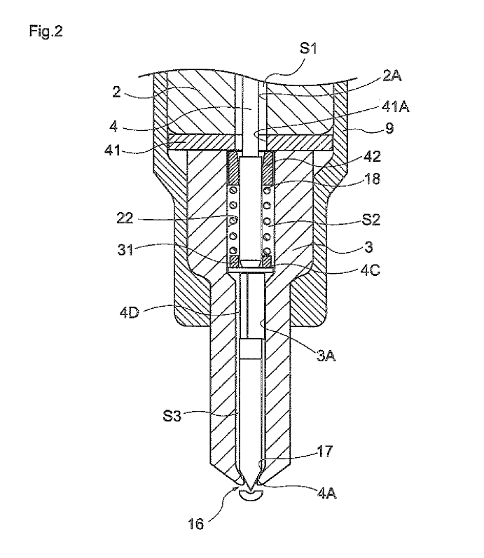

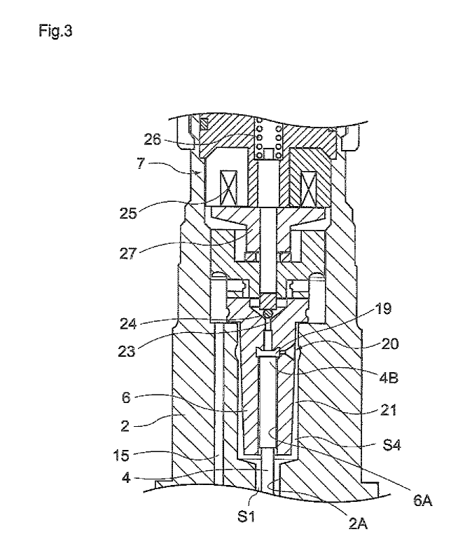

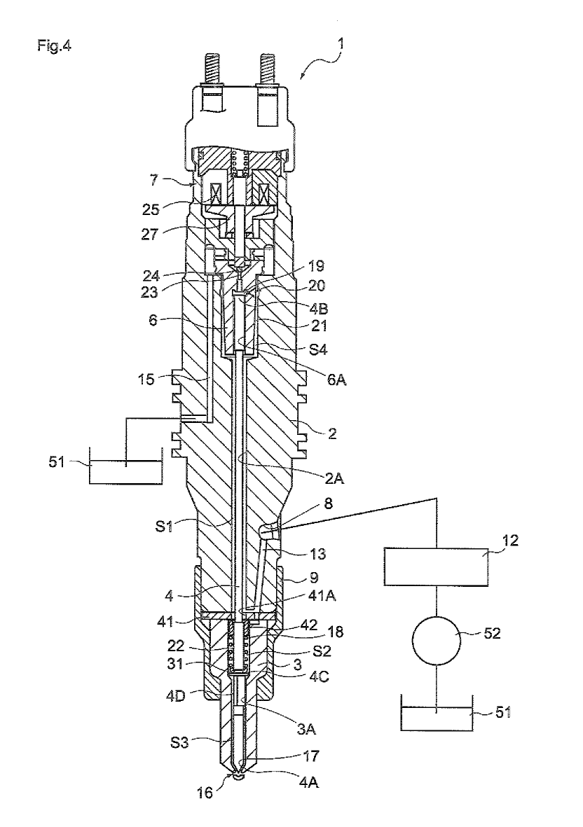

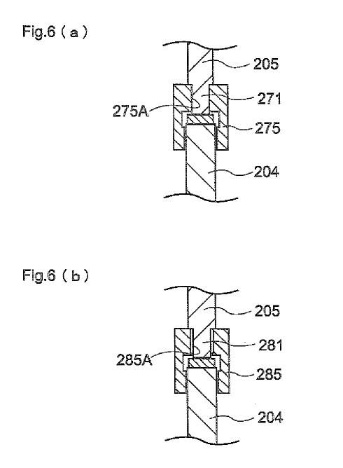

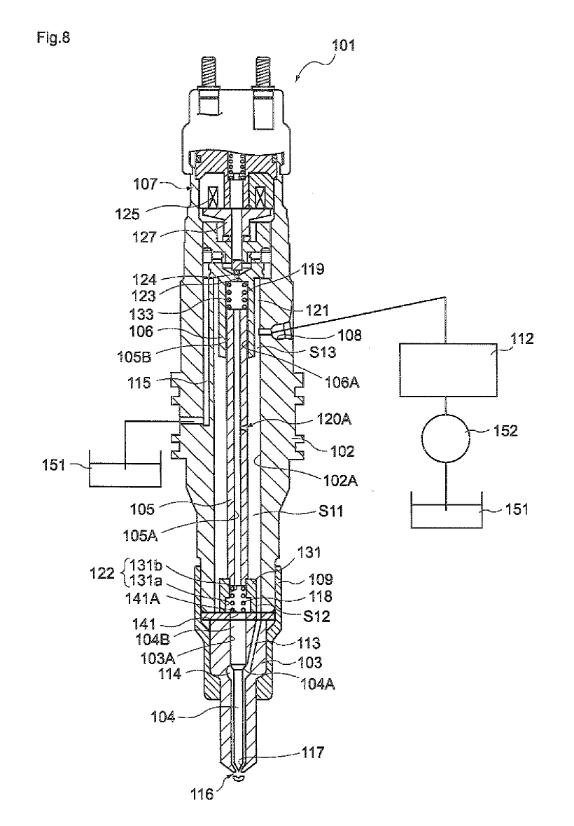

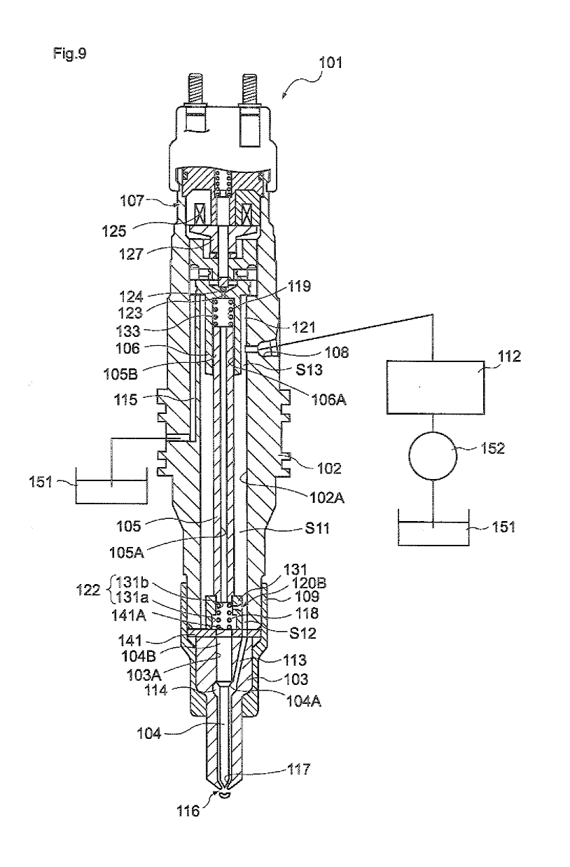

### BRIEF DESCRIPTION OF THE DRAWINGS

[FIG. 1] It is a configural diagram including a partial cross-sectional diagram showing the configuration of a common rail system in which a fuel injector of a first embodiment of the present invention is used.

[FIG. 2] It is an enlarged cross-sectional diagram of the area around a nozzle body of the fuel injector of the first embodiment.

[FIG. 3] It is an enlarged cross-sectional diagram of the area around a valve body of the fuel injector of the first embodiment.

[FIG. 4] It is a diagram showing a modification of the fuel injector of the first embodiment.

[FIG. 5] It is a configural diagram including a partial cross-sectional diagram showing the configuration of a common rail system in which a fuel injector of a second embodiment of the present invention is used.

[FIGS. 6] (a) and (b) are diagrams showing examples of a connecting structure that interconnects a valve piston and a nozzle needle.

[FIG. 7] It is a configural diagram including a partial cross-sectional diagram showing the configuration of a common rail system in which a fuel injector of a third embodiment the present invention is used.

[FIG. 8] It is a diagram showing a modification of the fuel injector of the third embodiment.

[FIG. 9] It is a diagram showing another modification of the fuel injector of the third embodiment.

[FIG. 10] It is a diagram for describing the configuration of a conventional fuel injector.

### BEST MODE FOR CARRYING OUT THE INVENTION

Below, embodiments relating to a fuel injector of the present invention will be specifically described. However, these embodiments represent one aspect of the present invention, are not intended to limit this invention, and are capable of being arbitrarily changed within the scope of the present invention.

It will be noted that members to which the same reference numerals have been given in the drawings represent identical members and that description thereof will be appropriately omitted.

### First Embodiment

A fuel injector pertaining to a first embodiment of the present invention will be described with reference to FIG. 1 to FIG. 4.

First, the overall configuration of a common rail system equipped with a fuel injector 1 of the present embodiment will be described with reference to a configural example shown in FIG. 1 and FIG. 2.

The common rail system has as its main components and is configured by a high pressure pump 52 that pumps fuel from a fuel tank 51, a common rail 12 in which the high-pressure fuel pumped by this high pressure pump 52 is accumulated and the fuel injector 1 that injects the high-pressure fuel accumulated inside the common rail 12 into cylinders of a diesel internal combustion engine (not shown). This configuration is basically identical to that of conventionally well known common rail systems.

The fuel injector 1 of the present embodiment has a configuration that differs from convention and is specific to the present application; the fuel injector I has as its main components and is configured by an injector housing 2, a nozzle body 3, a nozzle needle 4, a valve body 6 and a back pressure controller 7.

The nozzle body 3 is fastened by a nozzle nut 9 to the distal end portion (the lower end side in FIG. 1) of the injector housing 2. An injection hole 16 is drilled into the distal end portion of the nozzle body 3, and the nozzle body 3 has a structure where the injection hole 16 becomes closed as a result of the distal end portion of the nozzle needle 4 being seated on a seat portion 17 that leads to this injection hole 16 and where the injection hole 16 becomes opened as a result of the nozzle needle 4 being lifted from the seat portion 17. Thus, it becomes possible to start and stop fuel injection.

Further, a spring chamber 22 and a needle sliding hole 3A in which the nozzle needle 4 slides are formed inside the nozzle body 3 about the central axis of the nozzle body 3, and part of the nozzle needle 4 is disposed inside the spring chamber 22 and the needle sliding hole 3A.

Of these, inside the spring chamber 22, there is disposed a nozzle spring 18 for energizing the nozzle needle 4 in the direction of the seat portion 17, and a guide sleeve 42 that slides against the inner peripheral surface of the spring chamber 22 and a shim 31 that adjusts the set force of the nozzle spring 18 are disposed on the outer peripheral surface so as to be fitted on the exterior of the nozzle needle 4.

The guide sleeve 42 is configured using a cylindrical member that includes a needle sliding hole in which the nozzle needle 4 is slidable. This guide sleeve 42 is energized by the nozzle spring 18, and one end portion of the guide sleeve 42 contacts a spacer 41 disposed between the injector housing 2 and the nozzle body 3.

Further, the shim 31 similarly comprises a cylindrical member that includes a needle sliding hole, is energized by the nozzle spring 18 and contacts a projecting portion 4C of the nozzle needle 4.

Inside the injector housing 2, there is disposed a needle insertion hole 2A formed concentrically with the spring chamber 22 in the nozzle body 3, and part of the nozzle needle 4 is disposed in the needle insertion hole 2A. Further, in the middle portion of the injector housing 2, a high pressure fuel introduction opening 8, into which is introduced high-pressure fuel supplied from the common rail 12, is formed so as to face the needle insertion hole 2A. Part of the nozzle needle 4 is disposed inside the needle insertion hole 2A in this injector housing 2, and a space S1 is disposed around the nozzle needle 4 and serves as a high pressure fuel path through which the high-pressure fuel is introduced from the high pressure fuel introduction opening 8 to the inside of the fuel injector 1.

The spacer 41 is formed such that its outer shape is substantially cylindrical, and, between the nozzle body 3 and the injector housing 2, the spacer 41 is sandwiched between and held by these two members. A needle through hole 41A, into which the nozzle needle 4 is inserted, is formed in this spacer 41 about the central axis of the spacer 41. This needle through hole 41A is larger in diameter than the outer periphery of the nozzle needle 4, and the space between the nozzle needle 4 and the spacer 41 serves as a high pressure fuel path. Further, one end portion of the guide sleeve 42 contacts the spacer 41.

Further, the nozzle needle 4 disposed in the fuel injector 1 of the present embodiment is a long needle integrated from the nozzle body 3 to the injector housing 2 and is disposed so as to be reciprocally movable inside the needle sliding hole 3A and the spring chamber 22 inside the nozzle body 3, the needle insertion hole 2A inside the injector housing 2 and a needle sliding hole 6A inside the valve body 6.

The distal end portion of the portion of this nozzle needle 4 disposed inside the nozzle body 3 is capable of being seated on the seat portion 17 of the nozzle body 3. Further, in the fuel injector 1 of the present embodiment, a fuel reservoir chamber is not formed in the nozzle body 3 because a capacity capable of accumulating the high-pressure fuel is ensured inside the injector housing 2 and inside the nozzle body 3. For that reason, the distal end portion of the nozzle needle 4 is configured as is to be a pressure-receiving portion 4A that receives the pressure of the high-pressure fuel in order to lift the nozzle needle 4. Because of this configuration, working of the nozzle body 3 is done easily, stress concentration resulting from pulsation of pressure resulting from the opening and closing of the injection hole 16 and the like is avoided, and the durability of the fuel injector 1 can be improved.

Further, the middle portion of the nozzle needle 4 positioned inside the nozzle body 3 serves as a sliding portion that contacts the needle sliding hole 3A in the nozzle body 3. In the outer peripheral surface of the sliding portion of this nozzle needle 4, there is formed an axial direction groove 4D that becomes a high pressure fuel path.

Further, on the outer periphery of the portion of the nozzle needle 4 positioned inside the spring chamber 22, there is formed the projecting portion 4C that receives the energizing force of the nozzle spring 18, and the nozzle needle 4 is energized in the direction of the seat portion 17 as a result of receiving the energizing force via the shim 31.

Further, the portion of the nozzle needle 4 disposed inside the injector housing 2 is disposed inside the needle insertion hole 2A in the injector housing 2, and a proximal end portion 4B side of the nozzle needle 4 is disposed inside the needle sliding hole 6A in the valve body 6 and serves as a sliding portion that slides inside the needle sliding hole 6A.

In this fuel injector 1, the space S1 between the injector housing 2 and the nozzle needle 4, a space S2 around the nozzle needle 4 in the spring chamber 22, the axial direction groove 4D in the nozzle needle 4 and a space S3 between the nozzle needle 4 and the nozzle body 3 serve as a high pressure fuel path that extends from the high pressure fuel introduction opening 8 to the distal end side of the fuel injector 1. Meanwhile, the space S1 between the injector housing 2 and the nozzle needle 4 and a space S4 between the valve body 6 and the injector housing 2 serve as a high pressure fuel path that extends from the high pressure fuel introduction opening 8 to the proximal end side of the fuel injector 1. That is, the region from the injection hole 16 in the fuel injector 1 to an open/close orifice 23 in the back pressure controller 7 is all configured as a high pressure portion.

Inside the fuel injector 1, there is formed a fuel circulation path 15 that leads from the back pressure controller 7 to the fuel tank 51 via a back pressure control chamber 19 inside the valve body 6.

It will be noted that, in the example of the fuel injector 1 shown in FIG. 1, the high pressure fuel introduction opening 8 is formed so as to face the needle insertion hole 2A in the injector housing 2, but in the fuel injector 1 of the present embodiment, the region from the injection hole 16 to the open/close orifice 23 in the back pressure controller 7 is all configured as a high pressure portion, so the high pressure fuel introduction opening 8 may be formed so as to face any place of this high pressure portion. For example, as shown in FIG. 4, the high pressure fuel introduction opening 8 can also be formed so as to face the spring chamber 22 via a fuel passage 13 from the middle portion of the injector housing 2.

Next, the configuration of the area around the valve body 6 will be described with reference to FIG. 3. In FIG. 3, there is shown an enlarged cross-sectional diagram of the vicinity of the valve body 6 and the back pressure controller 7.

On the injection hole side (the lower side in FIG. 3) of the valve body 6, there is formed the needle sliding hole 6A in which the proximal end portion 4B of the nozzle needle 4 is disposed, the proximal end portion 4B of the nozzle needle 4 is inserted into the needle sliding hole 6A so as to face the back pressure controller 7 from below (the injection hole side), and the back pressure control chamber 19 is formed.

The back pressure control chamber 19 is communicated with an introduction orifice 20 formed in the valve body 6. This introduction orifice 20 is communicated with the space S1 that serves as the high pressure fuel path of the high-pressure fuel. Because of this configuration, the pressure introduced from the common rail 12 is supplied to the back pressure control chamber 19. The lower end side of the space S4 (in the direction of the end portion to which the needle sliding hole 6A opens) formed between this injector housing 2 and the valve body 6 is open and serves as a high pressure fuel path through which the high-pressure fuel passes.

Further, the back pressure control chamber 19 is also communicated with the open/close orifice 23, and the open/close orifice 23 is capable of being opened and closed by a valve ball (control valve) 24 of the later-described back pressure controller 7.

The back pressure controller 7 is configured to have a magnet 25, an armature 27, the valve ball 24, which is integrally attached to the armature 27, and the back pressure control chamber 19. Additionally, a drive signal is supplied from an unillustrated control circuit to the magnet 25, whereby the armature 27 becomes attracted to the magnet 25 counter to the energizing force of a valve spring 26 such that the valve ball 24 is lifted from the open/close orifice 23 and can release the pressure of the back pressure control chamber 19 to the fuel circulation path 15.

Consequently, by causing the valve ball 24 to operate as mentioned above to control the pressure of the back pressure control chamber 19 and control the back pressure of the nozzle needle 4, it becomes possible to control the seating of the nozzle needle 4 on the seat portion 17 and the lifting of the nozzle needle 4 from the seat portion 17.

In the fuel injector 1 of this configuration, the high-pressure fuel supplied from the common rail 12 acts on the pressure-receiving portion 4A on the distal end of the nozzle needle 4 via the high pressure fuel path including the space S1 between the nozzle needle 4 and the injector housing 2 from the high pressure fuel introduction opening 8 and also acts on the proximal end portion 4B of the nozzle needle 4 inside the back pressure control chamber 19 via the space S4 and the introduction orifice 20.

Consequently, when the back pressure control chamber 19 is blocked to the fuel low pressure side by the valve ball 24, the nozzle needle 4 receives the back pressure of the back pressure control chamber 19, becomes seated on the seat portion 17 of the nozzle body 3 in conjunction with the energizing force of the nozzle spring 18 and closes the injection hole 16.

On the other hand, when the armature 27 becomes attracted to the magnet 25 as a result of the drive signal being supplied at a predetermined timing to the magnet 25 such that the valve ball 24 opens the open/close orifice 23, the high pressure of the back pressure control chamber 19 travels through the fuel circulation path 15 via the open/close orifice 23 and refluxes to the fuel tank 51, so the high pressure that had acted on the proximal end portion 4B of the nozzle needle 4 in the back pressure control chamber 19 is released, the nozzle needle 4 becomes lifted from the seat portion 17 counter to the energizing force of the nozzle spring 18 by the high pressure acting on the pressure-receiving portion 4A and opens the injection hole 16, and fuel injection is performed.

Then, when the open/close orifice 23 becomes closed by the valve ball 24 as a result of the magnet 25 being demagnetized, the nozzle needle 4 becomes seated on the seat portion 17, which is its seated position, by the pressure inside the back pressure control chamber 19 such that the injection hole 16 becomes closed and fuel injection ends.

Next, fuel injection operation in the above-described configuration will be described.

First, the valve ball 24 is moved by the control of the back pressure controller 7 in the direction in which the open/close orifice 23 is closed, whereby the back pressure control chamber 19 becomes blocked to the fuel low pressure side and the high-pressure fuel from the common rail 12 is introduced. The high-pressure fuel from the common rail 12 is also introduced to the area around the pressure-receiving portion 4A on the distal end portion of the nozzle needle 4 via the high pressure fuel path around the nozzle needle 4.

Because of the high pressure acting on the proximal end portion 4B of the nozzle needle 4 because of the introduction of the high-pressure fuel, the nozzle needle 4 becomes seated on the seat portion 17 in conjunction with the energizing force of the nozzle spring 18 such that the injection hole 16 is closed and fuel injection is stopped. In this case, the position of the nozzle needle 4 in the axial direction becomes downward, that is, a position where the nozzle needle 4 has descended the most downward toward the injection hole 16.

The valve ball 24 is moved by the control of the back pressure controller 7 in the direction in which the open/close orifice 23 is opened, whereby the high-pressure fuel in the back pressure control chamber 19 is circulated to the fuel low pressure side via the open/close orifice 23 such that the nozzle needle 4 becomes lifted from the seat portion 17. In accompaniment therewith, injection of the high-pressure fuel is performed from the injection hole 16. Then, the nozzle needle 4 is lifted until it eventually contacts the end portion of the needle sliding hole 6A on the open/close orifice 23 side.

In the fuel injector 1 configured in this manner, the only member that reciprocally moves in order to open and close the injection hole 16 is the long nozzle needle 4, and there is no portion where different members receive pressure facing the axial direction and contact each other. Consequently, even when injecting fuel of a higher pressure than conventionally, wear of members is reduced and durability can be improved.

Further, the needle insertion hole 2A inside the injector housing 2 in which the nozzle needle 4 is disposed and the spring chamber 22 and the needle sliding hole 3A inside the nozzle body 3 are configured as the high pressure fuel path, so the capacity of the high-pressure fuel accumulated inside the fuel injector 1 is relatively large. Consequently, stress concentration resulting from pulsation accompanying the supply of the high-pressure fuel from the common rail 12 and the opening and closing of the injection hole 16 can be reduced and the durability of each member configuring the fuel injector 1 can be improved.

### Second Embodiment

Next, a fuel injector pertaining to a second embodiment of the present invention will be described with reference to FIG. 5. It will be noted that the basic operation of the fuel injector of the present embodiment is the same as that of the fuel injector of the first embodiment, so description thereof will be omitted and portions that are different will mainly be described.

A fuel injector 201 of the present embodiment has as its main components and is configured by an injector housing 202, a nozzle body 203, a nozzle needle 204, a valve piston 205, a valve body 206 and a back pressure controller 207.

The nozzle body 203 is, like the nozzle body that configures the fuel injector of the first embodiment, fastened by a nozzle nut 209 to the distal end portion of the injector housing 202. In contrast, a spring chamber is not formed inside the nozzle body 203 in the present embodiment, but rather a needle sliding hole 203A in which the nozzle needle 204 slides is formed inside the nozzle body 203 about the central axis of the nozzle body 3, and the nozzle needle 204 is disposed inside the needle sliding hole 203A.

Further, a fuel passage 213 that is communicated with an inner hole 202A in the injector housing 202 is formed in the nozzle body 203, and a fuel reservoir chamber 214 is formed in a site facing a pressure-receiving portion 204A of the nozzle needle 204.

However, in the fuel injector 201 of the present embodiment also, the capacity of the high-pressure fuel held inside the fuel injector 201 is large, so, like the first embodiment, the space around the nozzle needle 204 can be configured as a high pressure fuel path and the fuel reservoir chamber can be omitted.

Inside the injector housing 202, there is formed the inner hole 202A that includes a large diameter portion 202Aa on its distal end side, a small diameter portion 202Ab, and a large diameter portion 202Ac on its proximal end side, and in the middle portion of the injector housing 202, a high pressure fuel introduction opening 208, into which is introduced high-pressure fuel supplied from a common rail 212, is formed so as to face the small diameter portion 202Ab of the inner hole 202A. The valve body 206 and the valve piston 205 are disposed inside the inner hole 202A in this injector housing 202.

The valve piston 205 shown in FIG. 5 is configured using a cylindrical member and has a needle insertion hole 205D in its distal end portion 205A and a spring receiving portion 205C in its middle portion. The proximal end portion of the nozzle needle 204 is inserted into and fixed in the needle insertion hole 205D, and a shim 231 for adjusting the stroke amount is intervened on the proximal end portion side of the nozzle needle 204 inside the needle insertion hole 205D. Further, the spring receiving portion 205C receives one end of a spring 218 that energizes the valve piston 205 toward an injection hole 216. The other end of this spring 218 is received by a step portion at the boundary between the large diameter portion 202Aa and the small diameter portion 202Ab of the inner hole 202A in the injector housing 202. However, the spring receiving portion 205C of the valve piston 205 may also be omitted so that the spring 218 is directly received by the distal end portion 205A. A space S21 is formed around this valve piston 205 and serves as a high pressure fuel path through which the high-pressure fuel is introduced from the high pressure fuel introduction opening 208 to the inside of the fuel injector 201.

Further, the nozzle needle 204 disposed in the fuel injector 201 of the present embodiment is disposed so as to reciprocally movable inside the needle sliding hole 203A inside the nozzle body 203, and part of a proximal end portion 204B side of the nozzle needle 204 enters the inner hole 202A in the injector housing 202. Further, the valve piston 205 is connected to the proximal end portion 204B of the nozzle needle 204 and receives the energizing force of the spring 218. The distal end portion of this nozzle needle 204 is capable of being seated on a seat portion 217 of the nozzle body 203.

Whereas the fuel injector pertaining to the first embodiment employs a long nozzle needle, in the fuel injector 201 pertaining to the present embodiment, there is, instead of an integrated long needle, employed a configuration where the valve piston 205 and the nozzle needle 204 comprise separate bodies that are interconnected, and these two members slide integrally.

In an integrated long nozzle, at the time of assembly, it takes effort to align the clearance inside the needle sliding hole in the nozzle body and the clearance inside the needle sliding hole in the valve body so that both are in a suitable state. In contrast, when the valve piston 205 and the nozzle needle 204 are configured as separate bodies, even when misalignment between the centers of the nozzle needle 204 and the valve piston 205 arises, the misalignment is absorbed in the connecting portion between the nozzle needle 204 and the valve piston 205, so uneven wear resulting from the nozzle needle 204 or the valve piston 205 unevenly striking the sliding portion of the nozzle body 203 and the sliding portion of the valve body 206 can be reduced. Consequently, the clearance inside the needle sliding hole 203A in the nozzle body 203 and the clearance inside a valve piston sliding hole 206A in the valve body 206 can be independently set so that working efficiency at the time of assembly can be improved.

The connecting portion between the nozzle needle 204 and the valve piston 205 can, in addition to the configuration shown in FIG. 5, also be configured as exemplified in FIG. 6(a) or (b).

FIG. 6(a) shows an example where a connecting member 275 is press-fitted on the distal end portion of the valve piston 205 and where the proximal end portion of the nozzle needle 204 is inserted into and fixed in the connecting member 275. Further, FIG. 6(b) shows an example where the distal end portion of the valve piston 205 and a connecting member 285 are screwed together and where the proximal end portion of the nozzle needle 204 is inserted into and fixed in the connecting member 285.

In addition to these, the fuel injector can also be given a configuration having a connecting portion where the distal end portion of the valve piston 205 is inserted into and fixed in the proximal end side of the nozzle needle 204.

In this fuel injector 201, the space S21 between the injector housing 202 and the valve piston 205, a communicated portion S22 disposed in the end portion of the injector housing 202 and the fuel passage 213 formed in the nozzle body 203 are formed as a high pressure fuel path that extends from the high pressure fuel introduction opening 208 to the distal end side of the fuel injector 201. Meanwhile, the space S21 between the injector housing 202 and the valve piston 205 and a space S24 between the injector housing 202 and the valve body 206 are formed as a high pressure fuel path that extends from the high pressure fuel introduction opening 208 to the proximal end side of the fuel injector 201.

That is, the region from the injection hole 216 to an open/close orifice 223 in the back pressure controller 7 is configured as a high pressure portion.

Inside the fuel injector 201, there is formed a fuel circulation path 215 that leads from the back pressure controller 207 to a fuel tank 251 via a back pressure control chamber 219 inside the valve body 206.

Further, on the injection hole side of the valve body 206, there is formed the valve piston sliding hole 206A into which a proximal end portion 205B of the valve piston 205 is inserted, the proximal end portion 205B of the valve piston 205 is inserted into the valve piston sliding hole 206A so as to face the back pressure controller 207 from below (the injection hole 216 side), and the back pressure control chamber 219 is formed.

This back pressure control chamber 219 is communicated with an introduction orifice 220 formed in the valve body 206. This introduction orifice 220 is communicated with the space S24 that serves as the high pressure fuel path. Because of this configuration, the pressure introduced from the common rail 212 is supplied to the back pressure control chamber 219.

It will be noted that, in the fuel injector 201 of the present embodiment also, the lower end side of the space S24 (in the direction in which the valve piston sliding hole 206A opens) formed between the injector housing 202 and the valve body 206 is open and serves as a high pressure fuel path through which the high-pressure fuel passes.

Further, the back pressure control chamber 219 is also communicated with the open/close orifice 223, and the open/close orifice 223 is capable of being opened and closed by a valve ball (control valve) 224 of the back pressure controller 207. The configuration of the back pressure controller 207 can be made the same as the configuration of the back pressure controller that has been described in the first embodiment, so description here will be omitted.

In the fuel injector 201 of the present embodiment configured in this manner, the high-pressure fuel supplied from the common rail 212 acts on the pressure-receiving portion 204A of the nozzle needle 204 inside the fuel reservoir chamber 214 via the fuel passage 213 and the inner hole 202A in the injector housing 202 from the high pressure fuel introduction opening 208 and also acts on the proximal end portion 205B of the valve piston 205 inside the back pressure control chamber 219 via the space S24 and the introduction orifice 220.

Consequently, when the back pressure control chamber 219 is blocked to the fuel low pressure side by the valve ball 224, the valve piston 205 receives the back pressure of the back pressure control chamber 219 and causes the nozzle needle 204 to become seated on the seat portion 217 of the nozzle body 203 in conjunction with the energizing force of the nozzle spring 218 and close the injection hole 216.

On the other hand, when an armature 227 becomes attracted to a magnet 225 as a result of a drive signal being supplied at a predetermined timing to the magnet 225 such that the valve ball 224 opens the open/close orifice 223, the high pressure of the back pressure control chamber 219 travels through the fuel circulation path 215 via the open/close orifice 223 and refluxes to the fuel tank 251, so the high pressure that had acted on the proximal end portion 205B of the valve piston 205 in the back pressure control chamber 219 is released, the nozzle needle 204 becomes lifted from the seat portion 217 counter to the energizing force of the spring 218 by the high pressure acting on the pressure-receiving portion 204A and opens the injection hole 216, and fuel injection is performed.

Then, when the open/close orifice 223 becomes closed by the valve ball 224 as a result of the magnet 225 being demagnetized, the nozzle needle 204 becomes seated on the seat portion 217, which is its seated position, by the pressure inside the back pressure control chamber 219 via the valve piston 205 such that the injection hole 216 becomes closed and fuel injection ends.

In the fuel injector 201 configured in this manner, the nozzle needle 204 and the valve piston 205 that reciprocally move in order to open and close the injection hole 216 are connected and fixed to each other. Consequently, even when injecting fuel of a higher pressure than conventionally, wear of members is reduced and durability can be improved.

Further, the inner hole 202A in the injector housing 202 in which the valve piston 205 is disposed is configured as the high pressure fuel path, so the capacity of the high-pressure fuel held inside the fuel injector 201 is large. Consequently, stress concentration resulting from pulsation accompanying the supply of the high-pressure fuel from the common rail 212 and the opening and closing of the injection hole 216 can be reduced and the durability of each member configuring the fuel injector 201 can be improved.

It will be noted that fuel injection operation of the fuel injector of the present embodiment in the above-described configuration is the same as what has been described in the first embodiment, so description here will be omitted.

### Third Embodiment

Next, a fuel injector pertaining to a third embodiment of the present invention will be described with reference to FIG. 7. It will be noted that the basic operation of the fuel injector of the present embodiment is the same as that of the fuel injector of the first embodiment, so description thereof will be omitted and portions that are different will mainly be described.

A fuel injector 101 of the present embodiment has as its main components and is configured by an injector housing 102, a nozzle body 103, a nozzle needle 104, an intermediate member 105, a valve body 106 and a back pressure controller 107.

The nozzle body 103 is, like the nozzle body that configures the fuel injector of the first embodiment, fastened by a nozzle nut 109 to the distal end portion of the injector housing 102. Further, a spacer 141 is disposed between the injector housing 102 and the nozzle body 103. In contrast, a spring chamber is not formed in the nozzle body 103 in the present embodiment, but rather a needle sliding hole 103A in which the nozzle needle 104 slides is formed inside the nozzle body 103 about the central axis of the nozzle body 103, and the nozzle needle 104 is disposed inside the needle sliding hole 103A.

Further, a fuel passage 113 that is communicated with an inner hole 102A in the injector housing 102 is formed in the nozzle body 103, and a fuel reservoir chamber 114 is formed in a site facing a pressure-receiving portion 104A of the nozzle needle 104.

However, in the fuel injector 101 of the present embodiment also, the capacity of the high-pressure fuel held inside the fuel injector 101 is large, so, like the first embodiment, the space around the nozzle needle 104 can be configured as a high pressure fuel path and the fuel reservoir chamber can be omitted.

Inside the injector housing 102, there is formed the inner hole 102A that has a larger diameter than that of the needle sliding hole 103A inside the nozzle body 103, and in the middle portion of the injector housing 102, a high pressure fuel introduction opening 108, into which is introduced high-pressure fuel supplied from a common rail 112, is formed so as to face the inner hole 102A. The valve body 106, the intermediate member 105 and a cylinder member 131 are disposed inside the inner hole 102A in this injector housing 102.

The cylinder member 131 is formed such that a large diameter hole 131a on its nozzle body 103 side and a small diameter hole 131b on its valve body 106 side are communicated with each other inside. Additionally, the intermediate member 105 is fitted together with the small diameter hole 131b from the valve body 106 side, and a spring chamber 122 is formed by the large diameter hole 131a and part of the small diameter hole 131b. A nozzle spring 118 for energizing the nozzle needle 104 in the direction of a seat portion 117 of the nozzle body 103 is disposed in this spring chamber 122, and a proximal end portion 104B enters the spring chamber 122 when the nozzle needle 104 is lifted.

The intermediate member 105 is sandwiched between and held by the cylinder member 131 and a hold-down spring 133 disposed inside an intermediate member insertion hole 106A in the valve body 106, and a fuel passage hole 105A, both of whose axial direction end sides are open, is formed inside the intermediate member 105. Consequently, the spring chamber 122 inside the cylinder member 131 and the intermediate member insertion hole 106A inside the valve body 106 are in an equal pressure state.

Further, the end portion of the intermediate member 105 on an injection hole 116 side receives the nozzle spring 118.

The cylinder member 131 and the intermediate member 105 are held down and fixed by the hold-down spring 133 toward the nozzle body 103. The set force of this hold-down spring 133 is larger than the set force of the nozzle spring 118 and can reliably hold down the cylinder member 131 and the intermediate member 105 toward the nozzle body 103.

Further, a space S11 is formed around the cylinder member 131 and the intermediate member 105 and serves as a high pressure fuel path through which the high-pressure fuel is introduced from the high pressure fuel introduction opening 108 to the inside of the fuel injector 101.

The nozzle needle 104 disposed in the fuel injector 101 of the present embodiment is disposed so as to be reciprocally movable inside the needle sliding hole 103A inside the nozzle body 103, and part of the proximal end portion 104B side of the nozzle needle 104 enters the spring chamber 122 when the nozzle needle 104 is lifted. Further, the nozzle spring 118 contacts the proximal end portion 104B of the nozzle needle 104, and the proximal end portion 104B receives the energizing force of the nozzle spring 118.

The distal end portion of this nozzle needle 104 is capable of being seated on the seat portion 117 of the nozzle body 103, and the proximal end portion 104B side serves as a sliding portion that slides with respect to the needle sliding hole 103A.

In this fuel injector 101, the space S11 between the injector housing 102 and the intermediate member 105, a space S12 between the injector housing 102 and the cylinder member 131 and the fuel passage 113 formed in the nozzle body 103 are formed as a high pressure fuel path that extends from the high pressure fuel introduction opening 108 to the distal end side of the fuel injector 101. Meanwhile, a space S13 between the injector housing 102 and the valve body 106 is formed as a high pressure fuel path that extends from the high pressure fuel introduction opening 108 to the proximal end side of the fuel injector 101.

That is, the region from the injection hole 116 to an open/close orifice 123 in the back pressure controller 107 is configured as a high pressure portion.

Inside the fuel injector 101, there is formed a fuel circulation path 115 that leads from the back pressure controller 107 to a fuel tank 151 via a back pressure control chamber 119 inside the valve body 106.

Further, on the injection hole side of the valve body 106, there is formed the intermediate member insertion hole 106A in which a proximal end portion 105B of the intermediate member 105 is disposed, and the proximal end portion 105B of the intermediate member 105 is inserted into the intermediate member insertion hole 106A so as to face the back pressure controller 107 from below (the injection hole 116 side). In the fuel injector 101 of the present embodiment, the intermediate member insertion hole 106A in the valve body 106 and the spring chamber 122 in the cylinder member 131 are communicated with each other via the fuel passage hole 105A inside the intermediate member 105, and the intermediate member insertion hole 106A and the spring chamber 122 function overall as the back pressure control chamber 119.

Of this back pressure control chamber 119, the intermediate member insertion hole 106A in the valve body 106 is communicated with an introduction orifice 120 formed in the valve body 106. This introduction orifice 120 is communicated with the high pressure fuel path, and, because of this configuration, the pressure introduced from the common rail 112 is supplied to the back pressure control chamber 119.

It will be noted that, in the fuel injector 101 of the present embodiment also, the lower end side of the space S13 (in the direction in which the intermediate member insertion hole 106A opens) formed between the injector housing 102 and the valve body 106 is open and serves as a high pressure fuel path through which the high-pressure fuel passes.

In the case of the fuel injector 101 of the present embodiment, the introduction orifice 120 that introduces the pressure to the back pressure control chamber 119 is not limited to a configuration where it is formed in the valve body 106; as shown in FIG. 8, the introduction orifice 120 may also be disposed in the intermediate member 105 (120A), or, as shown in FIG. 9, the introduction orifice 120 may also be disposed in the cylinder member 131 (120B). That is, it suffices for the introduction orifice 120 to be formed such that it can introduce the high-pressure fuel to any place of the back pressure control chamber 119 that is configured as a result of the intermediate member insertion hole 106A being communicated with the spring chamber 122 via the fuel passage hole 105A in the intermediate member 105.

It will be noted that the high pressure fuel introduction opening 108 formed in the injector housing 102 can also be formed in an appropriate position as long as it is a place where the high pressure fuel introduction opening 108 is communicable with the inner hole 102A in the injector housing 102.

Further, the back pressure control chamber 119 is also communicated with the open/close orifice 123, and the open/close orifice 123 is capable of being opened and closed by a valve ball (control valve) 124 of the back pressure controller 107. The configuration of the back pressure controller 107 can be made the same as the configuration of the back pressure controller described in the first embodiment, so description here will be omitted.

In the fuel injector 101 of the present embodiment configured in this manner, the high-pressure fuel supplied from the common rail 112 acts on the pressure-receiving portion 104A of the nozzle needle 104 inside the fuel reservoir chamber 114 via the fuel passage 113 and the inner hole 102A in the injector housing 102 from the high pressure fuel introduction opening 108 and also acts on the proximal end portion 104B of the nozzle needle 104 inside the back pressure control chamber 119 via the space S13 and the introduction orifice 120.

Consequently, when the back pressure control chamber 119 is blocked to the fuel low pressure side by the valve ball 124, the nozzle needle 104 receives the back pressure of the back pressure control chamber 119, becomes seated on the seat portion 117 of the nozzle body 103 in conjunction with the energizing force of the nozzle spring 118 and closes the injection hole 116.

On the other hand, when an armature 127 is attracted to a magnet 125 as a result of a drive signal being supplied at a predetermined timing to the magnet 125 such that the valve ball 124 opens the open/close orifice 123, the high pressure of the back pressure control chamber 119 travels through the fuel circulation path 115 via the open/close orifice 123 and refluxes to the fuel tank 151, so the high pressure that had acted on the proximal end portion 104B of the nozzle needle 104 in the back pressure control chamber 119 is released, the nozzle needle 104 becomes lifted from the seat portion 117 counter to the energizing force of the nozzle spring 118 by the high pressure acting on the pressure-receiving portion 104A and opens the injection hole 116, and fuel injection is performed.

Then, when the open/close orifice 123 becomes closed by the valve ball 124 as a result of the magnet 125 being demagnetized, the nozzle needle 104 becomes seated on the seat portion 117, which is its seated position, by the pressure inside the back pressure control chamber 119 such that the injection hole 116 becomes closed and fuel injection ends.

In the fuel injector 101 configured in this manner, the only member that reciprocally moves in order to open and close the injection hole 116 is the nozzle needle 104, and there is no portion where different members receive pressure facing the axial direction and contact each other. Consequently, even when injecting fuel of a higher pressure than conventionally, wear of members is reduced and durability can be improved.

Further, the inner hole 102A in the injector housing 102 in which the intermediate member 105 and the cylinder member 131 are disposed is configured as the high pressure fuel path, so the capacity of the high-pressure fuel held inside the fuel injector 101 is large. Consequently, stress concentration resulting from pulsation accompanying the supply of the high-pressure fuel from the common rail and the opening and closing of the injection hole 116 can be reduced and the durability of each member configuring the fuel injector 101 can be improved.

It will be noted that fuel injection operation of the fuel injector of the present embodiment in the above-described configuration is the same as what has been described in the first embodiment, so description here will be omitted.

1-8. (canceled)

9. A fuel injector comprising:
a nozzle body which has an injection hole formed at a distal end portion thereof;
a nozzle needle that is disposed so as to be movable in an axial direction inside the nozzle body and opens and closes the injection hole as a result of being lifted and seated; and
an injector housing that is connected to the nozzle body and enables high-pressure fuel to be introduced to and discharged from a proximal end portion side of the nozzle needle in order to lift and seat the nozzle needle, and being supplied the high-pressure fuel from a common rail in which the high-pressure fuel is accumulated under pressure,
wherein the fuel injector has, on the proximal end portion side of the nozzle needle inside the injector housing, a valve body in which a discharge hole for discharging the high-pressure fuel is formed and a valve that opens and closes the discharge hole as a result of being lifted and seated in the axial direction, and
wherein a space between the valve body and the injector housing is open on a nozzle body side as a supply passage of the high-pressure fuel supplied from the common rail.

10. The fuel injector according to claim 9, wherein the nozzle needle is a long needle whose distal end portion is capable of being seated on a seat surface of the nozzle body and whose proximal end portion is slidably held in the valve body.

11. The fuel injector according to claim 10, wherein a space between the long needle and the injector housing serves as a high pressure portion which is in communication with the space between the valve body and the injector housing.

12. The fuel injector according to claim 9, wherein the proximal end portion of the nozzle needle is connected to a valve piston that is slidably held in the valve body, and an area around the valve piston serves as a high pressure portion.

13. The fuel injector according to claim 9, further comprising: an intermediate member that is disposed between the valve body and the nozzle needle and includes a high pressure fuel path which has both open axial direction ends; and a nozzle spring that is disposed between the intermediate member and the nozzle needle and that energizes the nozzle needle.

14. The fuel injector according to claims 9, wherein the distal end portion of the nozzle needle is a pressure-receiving portion for lifting the nozzle needle.

15. The fuel injector according to claims 10, wherein the distal end portion of the nozzle needle is a pressure-receiving portion for lifting the nozzle needle.

16. The fuel injector according to claims 11, wherein the distal end portion of the nozzle needle is a pressure-receiving portion for lifting the nozzle needle.

17. The fuel injector according to claims 12, wherein the distal end portion of the nozzle needle is a pressure-receiving portion for lifting the nozzle needle.

18. The fuel injector according to claims 13, wherein the distal end portion of the nozzle needle is a pressure-receiving portion for lifting the nozzle needle.

19. A fuel injector comprising:
a nozzle body which has an injection hole formed at a distal end portion thereof;
a nozzle needle that is disposed so as to be movable in an axial direction inside the nozzle body and opens and closes the injection hole as a result of being lifted and seated; and
an injector housing that is connected to the nozzle body and enables high-pressure fuel to be introduced to and discharged from a proximal end portion side of the nozzle needle in order to lift and seat the nozzle needle, and being supplied the high-pressure fuel from a common rail in which the high-pressure fuel is accumulated under pressure,
wherein the fuel injector has, on the proximal end portion side of the nozzle needle inside the injector housing, a valve body in which a discharge hole for discharging the high-pressure fuel is formed and a valve that opens and closes the discharge hole as a result of being lifted and seated in the axial direction, and
wherein a space between the valve body and the injector housing is open on a nozzle body side as a part of the high pressure fuel passage that introduces the high-pressure fuel supplied from the common rail to the injection hole side or the proximal end portion side of the nozzle needle.

20. A fuel injector comprising:
a nozzle body which has an injection hole formed at a distal end portion thereof;
a nozzle needle that is disposed so as to be movable in an axial direction inside the nozzle body and opens and closes the injection hole as a result of being lifted and seated; and
an injector housing that is connected to the nozzle body and enables high-pressure fuel to be introduced to and discharged from a proximal end portion side of the nozzle needle in order to lift and seat the nozzle needle, and being supplied the high-pressure fuel from a common rail in which the high-pressure fuel is accumulated under pressure,
wherein the fuel injector has, on the proximal end portion side of the nozzle needle inside the injector housing, a valve body in which a discharge hole for discharging the high-pressure fuel is formed and a valve that opens and closes the discharge hole as a result of being lifted and seated in the axial direction, and
wherein a space between the valve body and the injector housing is open on a nozzle body side, and a space including an opened portion is configured as a capacity increasing portion in which the high-pressure fuel supplied from the common rail is accumulated.
